(19) United States
(12) Patent Application Publication
(10) Pub. No.: US 2016/0260246 A1
(43) Pub. Date: Sep. 8, 2016

(54) PROVIDING ASYNCHRONOUS DISPLAY SHADER FUNCTIONALITY ON A SHARED SHADER CORE

(71) Applicant: Advanced Micro Devices, Inc., Sunnyvale, CA (US)

(72) Inventors: David Oldcorn, Fleet (GB); Chris Brennan, Boxborough, MA (US); Michael Mantor, Orlando, FL (US); Layla A. Mah, Boxborough, MA (US)

(73) Assignee: Advanced Micro Devices, Inc., Sunnyvale, CA (US)

(21) Appl. No.: 14/635,280

(22) Filed: Mar. 2, 2015

(51) Int. Cl. G06T 15/80

(52) U.S. Cl. CPC G06T 15/80

(57) ABSTRACT

A method, a non-transitory computer readable medium, and a processor for performing display shading for computer graphics are presented. Frame data is received by a display shader, the frame data including at least a portion of a rendered frame. Parameters for modifying the frame data are received by the display shader. The parameters are applied to the frame data by the display shader to create a modified frame. The modified frame is displayed on a display device.

### TECHNICAL FIELD

The disclosed embodiments are generally directed to graphics processing, and in particular, to providing an asynchronous display shader on a shared shader core with multiple input queues.

### BACKGROUND

Currently, when rendering of a 3D frame is completed, the rendered frame is handed off to a display device for display. This process is generally simple—the data is read out from a scan buffer and is sent to the display device.

Graphics hardware currently includes shader programs that instruct the computer to draw something in a specific way, including applying various effects. A shader may be modified by external parameters provided by the program calling the shader. There are shaders of various types, and each type of shader is applied at a different point in the graphics pipeline. Some shaders are applied when converting the input representations of 3D objects into coordinates of the triangles displayed on-screen that make up a rendered image. Other shaders are applied while each of the individual triangles is being rendered, to map them onto the screen.

Once a frame is rendered, there is no opportunity to perform additional operations timed to the display refresh(es) after that. This can be emulated with an extra pass after rendering, if the rendering is faster than the display refresh and completes before the display refresh begins. But this cannot be guaranteed given the variable rendering workload.

This is because rendering occurs at a “rendering rate,” which is variable and based on the 3D rendering workload. Display occurs at a “display rate,” which happens at the display device's scan-out rate. A display shader would permit work to be scheduled to be completed at the “display rate” independent of the “rendering rate,” to which there is currently no solution.

One current solution is to perform the display shading synchronously by waiting until the rendering is complete, running the display shader in one large burst (to quickly let the more rendering begin), and then scheduling the result to be displayed. But this solution requires that all inputs are known when rendering begins and may use one snapshot of the inputs across the entire frame. This may entail waiting for the inputs, which has a long and unpredictable latency and is therefore unacceptable in use cases where low latency is required. To be able to perform computation pacing with the “display rate” that has as little latency from the inputs to scan-out as possible, there needs to be an asynchronous computation that can always access the latest inputs as it performs the scan-out.

Using a standalone display shader would perform the additional operations closer to real-time by taking the final output of rendering and transforming it on a just-in-time basis before sending it to the display.

### SUMMARY OF EMBODIMENTS

Some embodiments provide a method for performing display shading for computer graphics. Frame data is received by a display shader, the frame data including at least a portion of a rendered frame. Parameters for modifying the frame data are received by the display shader. The parameters are applied to the frame data by the display shader to create a modified frame. The modified frame is displayed on a display device.

Some embodiments provide a non-transitory computer-readable storage medium storing a set of instructions for execution by a general purpose computer to perform display shading for computer graphics. The set of instructions includes a first receiving code segment, a second receiving code segment, an applying code segment, and a displaying code segment. The first receiving code segment receives frame data by a display shader, the frame data including at least a portion of a rendered frame. The second receiving code segment receives parameters by the display shader, the parameters for modifying the frame data. The applying code segment applies the parameters to the frame data by the display shader to create a modified frame. The displaying code segment displays the modified frame.

Some embodiments provide a processor configured to perform display shading for computer graphics. The processor includes a command processor, a shader core, and a shader pipe. The shader core can be shared by multiple processes. The shader pipe is configured to communicate between the command processor and the shader core. A display shader is a program that is sent by the command processor to be executed on the shader core. The display shader is configured to receive frame data, the frame data including at least a portion of a rendered frame; receive parameters for modifying the frame data; and apply the parameters to the frame data to create a modified frame.

### BRIEF DESCRIPTION OF THE DRAWINGS

A more detailed understanding may be had from the following description, given by way of example in conjunction with the accompanying drawings, wherein:

FIG. 1 is a block diagram of an example device in which one or more disclosed embodiments may be implemented;

FIG. 2 is a block diagram of an example processor in which one or more disclosed embodiments may be implemented;

FIG. 3 is a flow diagram of data flow to and from a display shader; and

FIG. 4 is a flow chart of a method to process data by the display shader.

### DETAILED DESCRIPTION

A method, a non-transitory computer readable medium, and a processor for performing display shading for computer graphics are presented. Frame data is received by a display shader, the frame data including at least a portion of a rendered frame. Parameters for modifying the frame data are received by the display shader. The parameters are applied to the frame data by the display shader to create a modified frame. The modified frame is displayed on a display device.

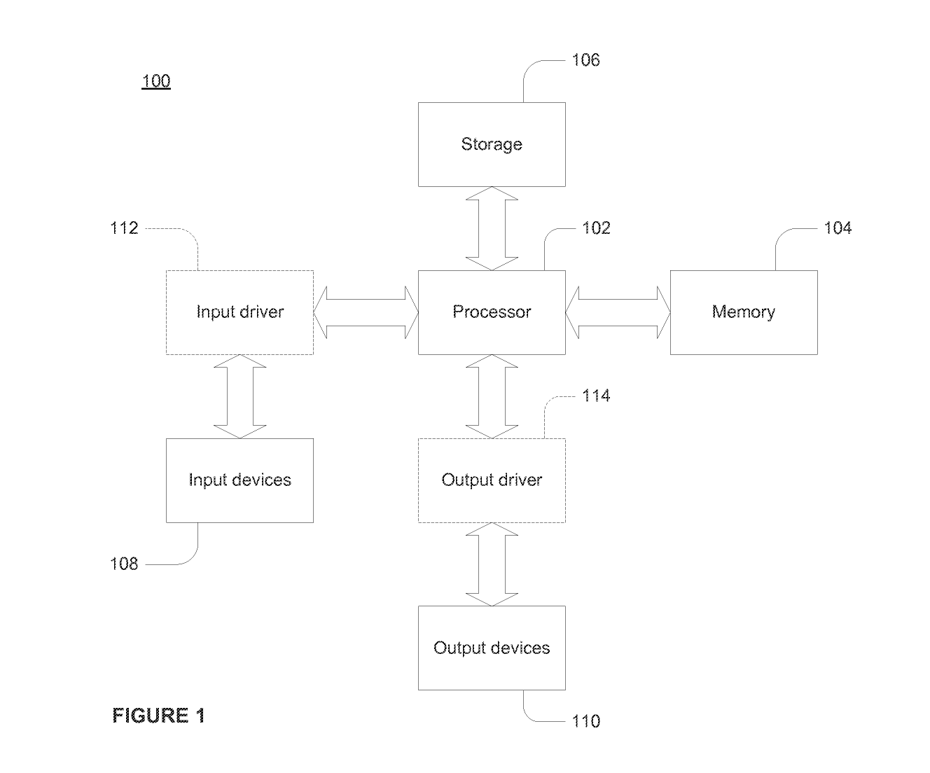

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

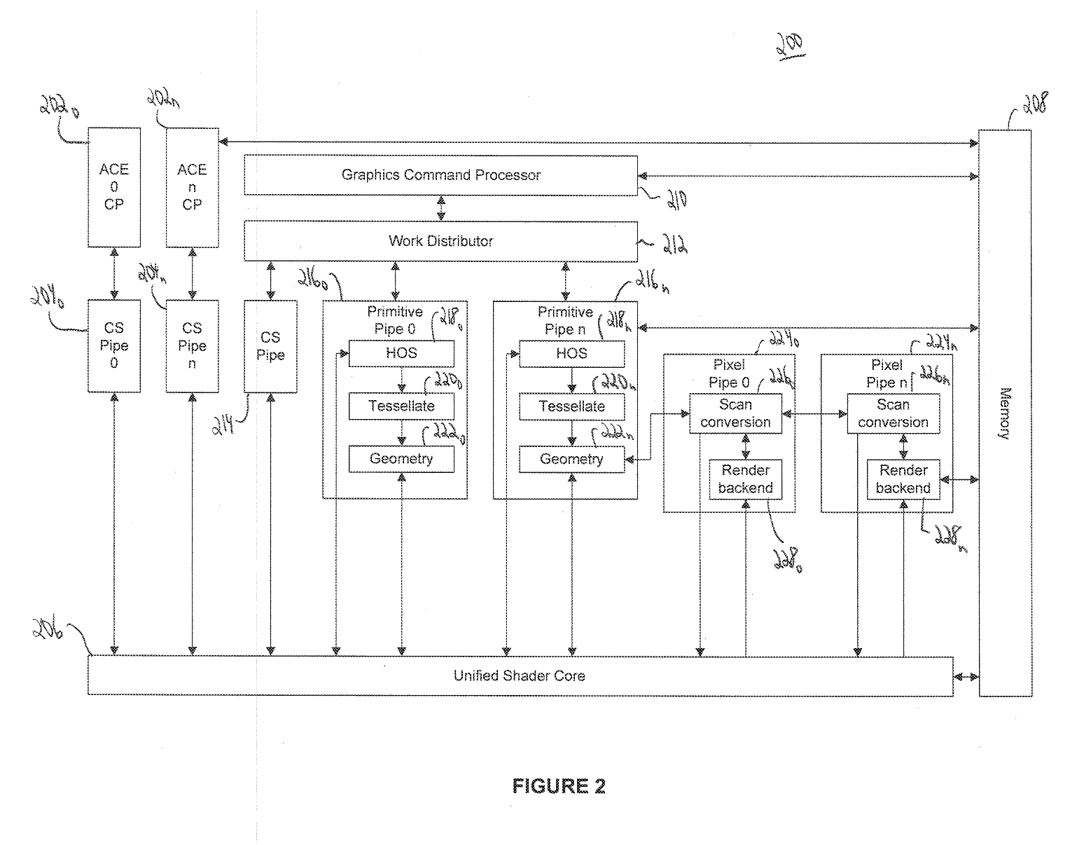

FIG. 2 is a block diagram of an example processor 200 in which one or more disclosed embodiments may be implemented. It is noted that the processor 200 may include other components not shown in FIG. 2; for purposes of discussion, only those portions of the processor relevant to the display shader operation are shown in FIG. 2. It is also noted that where there is a plurality of the same element, that element is discussed in the singular to simplify the explanation, but the operation of the element is the same for each of the plurality. To simplify FIG. 2, where plural elements communicate with different elements, the communication path is shown via only one of the plural elements.

The processor 200 includes a plurality of asynchronous compute engine (ACE) command processors (CP) 202₀-202ₙ. Each ACE CP 202 communicates with a corresponding compute shader (CS) pipe 204₀-204ₙ. Each CS pipe 204 communicates with a unified shader core 206. The unified shader core 206 communicates with a memory 208. Each ACE CP 202 is capable of adding work into the unified shader core 206 in a prioritized manner.

A graphics command processor 210 receives and processes graphics commands from an application (not shown in FIG. 2). The graphics command processor 210 communicates with the memory 208 and sends work items to a work distributor 212. The work distributor 212 distributes the work items to a CS pipe 214 and to a plurality of primitive pipes 216₀-216ₙ. Each primitive pipe 216 performs primitive scaling and communicates with the memory 208. Each primitive pipe 216 includes a high order surface shader 218, a tessellator 220, and a geometry shader 222. The high order surface shader 218 provides a high order surface to the tessellator 220, which divides the high order surface into primitives. The primitives are then processed by the geometry shader 222. Both the high order surface shader 218 and the geometry shader 222 communicate with the unified shader core 206.

The processor 200 also includes a plurality of pixel pipes 224₀-224ₙ. Each pixel pipe 224 performs pixel scaling and includes a scan converter 226 and a render backend 228. The geometry shader 222 in the primitive pipe 218 communicates with the scan converter 226 in the pixel pipe 224. The scan converters 226 in each pixel pipe 224 communicate with each other and send data to the unified shader core 206. The render backend 228 communicates with the memory 208 and receives data from the unified shader core 206.

In the processor 200, the display shader is a shader program executed on the unified shader core 206. The display shader is implemented by duplicating at least a portion of the frame buffer memory (which is part of the memory 208), pointing the display controller at this duplicate frame buffer, and running a just-in-time process in the unified shader core 206 on the data in the original frame buffer to generate the actual output buffer, which is stored in the duplicate frame buffer. In this context, “just-in-time” means that the display shader is run close to real-time after the frame is generated and prior to scan-out and display. The amount of frame buffer memory that needs to be duplicated depends on the display strobe pattern. Duplicating the entire frame buffer memory may not be necessary, but doing so provides a simple implementation.

The inputs to the display shader are a last generated full 3D frame and the most up-to-date parameters the display shader requires to turn that frame into the display image. It is noted that instead of the last generated full 3D frame, the display shader may receive the last N frames and may also receive depth information, motion information, or more than one layer for composition. The parameters may include, but are not limited to, user interface updates, pointer location, head tracking data, eye tracking data, timestamps for rendered frames, or a current display time. The scope of the parameters supplied to the display shader may be based on an implementation of the display shader selected by a programmer. In one implementation, any information provided to the display shader (including frame data and parameter information) may be provided as pointers to the information, to be retrieved when the display shader is executed on the unified shader core.

Supplying these inputs to the display shader allows the actual display output to be generated with minimum latency. The frame buffer does not need to be full before the display shader begins processing the data. A relatively small buffer can be used to begin the process.

The display shader is executed by loading a program on an ACE CP 202, which submits a high priority request to the unified shader core 206. The submitted work contains the display shading operation. The unified shader core 206 accepts the work from the ACE CP 202 and starts on that work in very short order, due to the high priority request. The display shader must produce its results ahead of the display scan-out. This requires some method to ensure quality of service; examples of quality of service methods are described in greater detail below. It may not be acceptable to wait for other queued work to complete, as the other queued work may require an arbitrary length of time to execute. Once the unified shader core 206 is at least partially free of other work, the priority mechanism in the unified shader core 206 prioritizes the display shader such that it is scheduled ahead of competing workloads.

One ACE CP 202 may be dedicated to running a display shader initiation process. It tracks the position that the display controller is reading from the post-processed frame buffer, and when it reaches the initiation point, it starts up the display shader process in the unified shader core 206.

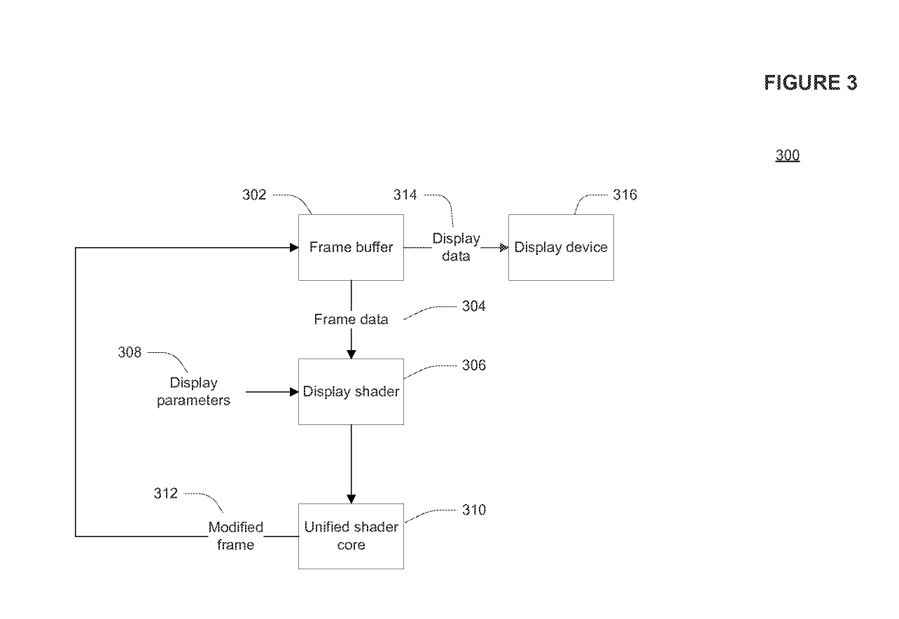

FIG. 3 is a flow diagram 300 of data flow to and from a display shader. A frame buffer 302 provides frame data 304 to a display shader 306. The display shader 306 obtains display parameters 308 from memory (not shown in FIG. 3) and sends the frame data 304 and the display parameters 308 to a unified shader core 310. The unified shader core 310 executes the display shader 306 to generate a modified frame 312 that is stored in the frame buffer 302. Display data 314 is scanned out of the frame buffer 302 for display on a display device 316.

In one embodiment, the destination duplicated frame buffer may be limited in size and located on the chip to reduce the power drain of writing data to remote memory and reading the data back in. This embodiment is possible if the results can be guaranteed to be available in time for the scan-out.

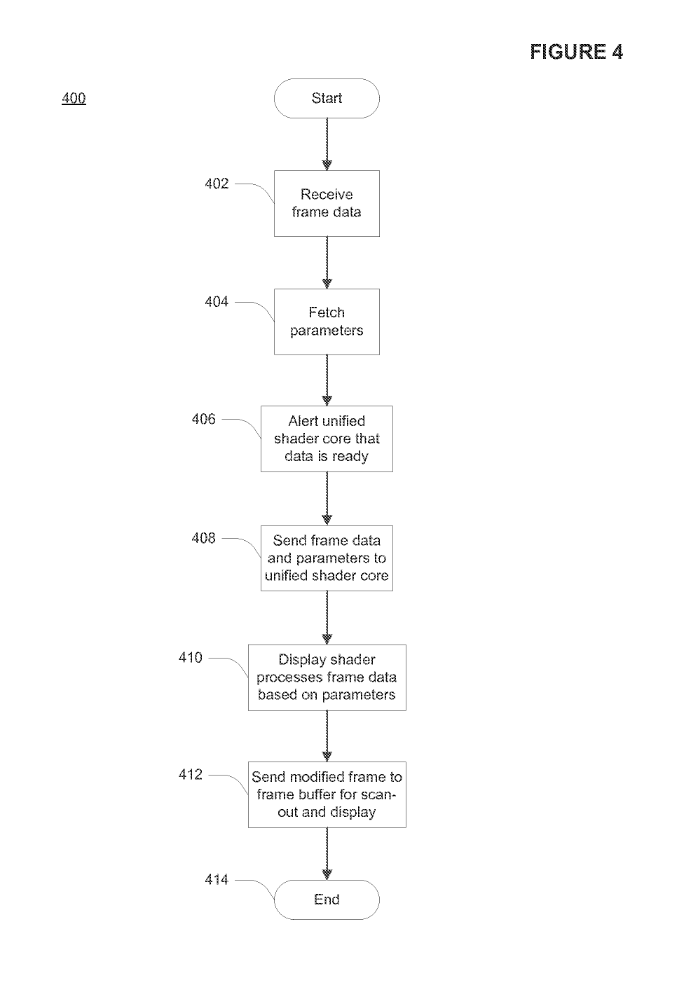

FIG. 4 is a flow chart of a method 400 to process data by the display shader. The display shader receives frame data, which is at least a portion of a 3D frame to be rendered (step 402) and fetches display parameters from memory (step 404). Once the display shader has the necessary frame data and parameters, it alerts the unified shader core that it is ready to execute (step 406).

Once the ACE CP where the display shader is running receives an indication from the unified shader core that it is available, the ACE CP sends the frame data and the parameters to the unified shader core (step 408), where the display shader processes the frame data based on the parameters (step 410). The processed data is sent from the unified shader core to the frame buffer for scan-out and display on the display device (step 412) and the method terminates (step 414). It is noted that the steps of the method 400 may at least partially overlap. For example, some data could be read from the scan-out buffer for display while other data is concurrently being processed. This means that a portion of a frame can be read out of the buffer and displayed while another portion of the same frame is being processed.

The display shader makes the latency between the application making the changes and the image appearing on the display as low as possible. This low latency can be achieved because the display shading process takes less time to complete than the original frame rendering. The low latency also enables the display rate to be decoupled from the rendering rate. The display shader may be run at high priority, to guarantee minimum latency or low priority, to minimize the impact on other workloads. If run at low priority, the initiation point must be adjusted earlier to ensure that the shader has time to complete.

Because the display shader is implemented as a just-in-time process, there needs to be some sort of quality of service (QoS) guarantee. If the display shader does not complete its processing on time, then the display scan runs ahead of the data in the scan-out buffer and “garbage” (i.e., the wrong data) is displayed on the screen.

There needs to be a high level of confidence that the display shader can complete its work in the latency time allowed. There is no hard limit as to the permitted latency time allowed, but the display shader needs to complete its work close to the predicted length of time, very nearly all the time. The prioritization in the unified shader core helps to meet the QoS guarantee. With the prioritization, the display shader can effectively “take over” the entire shader core until it has completed its operations.

In one implementation, the unified shader core will wait until any existing work is completed before executing the display shader, even though the display shader is run with a high priority. In a second implementation, work currently underway in the unified shader core may be interrupted, to permit the display shader to run. In a third implementation, there may be room on the unified shader core to run the display shader, even if there is existing work currently being done.

In a fourth implementation, resources for the display shader can be pre-reserved, such that when the display shader is ready to run, it can run and does not need to wait for existing work on the unified shader core to complete. In this implementation, the work is not scheduled onto the ACE CP until it is known that the data is ready. Alternatively, if the data is transient, the data may be updated in a dynamic manner during the display shading process.

There are several possible ways to keep the initiator process running on the ACE CP:

(1) Use an existing streaming engine and regularly feed it with new instances of the initiator process, each of which sleeps until the initiation point and terminates afterwards. If the operating system (OS) provides queues which automatically fill the ACE CP when a previous process retires, this can be achieved by using a CPU connected to the graphics controller, as long as the worst-case latency of process start is longer than the interval between initiations and the cost of rescheduling is not too high.

(2) Start and stop a looped continuous process on the ACE CP. This method might not be acceptable if GPU processes are required to exit in a finite amount of time, which is true on some OSes.

(3) A hybrid of the above: the ACE CP process is scheduled once per frame, and the single process loops and executes a fixed number of initiation points before exiting.

The pattern of display shader execution needs to be matched to the pattern of strobe on the display device if minimum latency is to be maintained. For example, if the display is strobed in one pass, the display shader needs to execute once per display frame. If the display is strobed top half and bottom half, the display shader executes twice per frame, once on each half. If the display is continuously strobed, the display shader ideally would be executed per pixel, but in realistic circumstances is likely to be executed every few display scan lines. To determine the strobe pattern of the display device, the display shader may communicate with the device or the pattern may be set by a programmed table or assumption.

For most display shading algorithms, there is a method of snapshotting the input parameters at initiation time. Not all parameters may need to be updated precisely simultaneously; generally, groups of parameters will require an atomic update (e.g., a transformation matrix or the buffer location of a previously completed frame to be processed).

In a system with multiple GPUs (including an accelerated processing unit (APU) and GPU combination), the display shader need only execute on one GPU. It is usually most convenient to execute the display shader on the GPU which is closest to the display port or display controller, to avoid the latency cost of transfer across a slow system bus, although this is not a requirement.

The display shader may be used in various situations, including, but not limited to:

(1) Asynchronous time warping for virtual reality headset display latency reduction.

(2) Other low latency composition, including mouse pointer overlays of higher complexity or frame rate conversion. For example, with a 4K display device, there may be a large and complicated cursor. During game play, a player desires an instantaneous cursor response; any latency in moving the cursor around the screen would adversely affect game play.

(3) Temporal antialiasing and frame accumulation.

(4) Motion compensated frame rate conversion.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, a processor core, or the display device. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing display shading for computer graphics, comprising:
receiving frame data by a display shader, wherein the frame data includes at least a portion of a rendered frame;
receiving parameters by the display shader, the parameters for modifying the frame data;
applying the parameters to the frame data by the display shader to create a modified frame; and
displaying the modified frame.

2. The method according to claim 1, wherein the display shader is executed on a shader core which can be shared by multiple processes.

3. The method according to claim 2, wherein the shader core includes a priority mechanism wherein the display shader can be executed with a higher priority than other processes on the shader core.

4. The method according to claim 2, further comprising:
alerting the shader core that the display shader is ready to execute.

5. The method according to claim 1, wherein the displaying includes:
storing the modified frame in a buffer by the display shader; and
reading the modified frame from the buffer to be displayed.

6. A non-transitory computer-readable storage medium storing a set of instructions for execution by a general purpose computer to perform display shading for computer graphics, the set of instructions comprising:
a first receiving code segment for receiving frame data by a display shader, wherein the frame data includes at least a portion of a rendered frame;
a second receiving code segment for receiving parameters by the display shader, the parameters for modifying the frame data;
an applying code segment for applying the parameters to the frame data by the display shader to create a modified frame; and
a displaying code segment for displaying the modified frame.

7. The non-transitory computer-readable storage medium according to claim 6, further comprising:
an alerting code segment for alerting a shader core that the display shader is ready to execute.

8. The non-transitory computer-readable storage medium according to claim 6, wherein the displaying code segment includes:
a storing code segment for storing the modified frame in a buffer by the display shader; and
a reading code segment for reading the modified frame from the buffer to be displayed.

9. The non-transitory computer-readable storage medium according to claim 6, wherein the instructions are hardware description language (HDL) instructions used for the manufacture of a device.

10. A processor configured to perform display shading for computer graphics, comprising:
a command processor;
a shader core which can be shared by multiple processes; and
a shader pipe, configured to communicate between the command processor and the shader core,
wherein a display shader is a program that is sent by the command processor to be executed on the shader core, the display shader configured to:
receive frame data, wherein the frame data includes at least a portion of a rendered frame;
receive parameters for modifying the frame data; and
apply the parameters to the frame data to create a modified frame.

11. The processor according to claim 10, wherein the shader core includes a priority mechanism wherein the display shader can be executed with a higher priority than other processes on the shader core.

12. The processor according to claim 10, wherein the command processor is configured to alert the shader core that the display shader is ready to execute.

13. The processor according to claim 10, further comprising:
a buffer, configured to receive the modified frame from the display shader.

14. A non-transitory computer-readable storage medium storing a set of instructions for execution by one or more processors to facilitate manufacture of a processor configured to perform display shading for computer graphics, the processor comprising:
a command processor;
a shader core which can be shared by multiple processes; and
a shader pipe, configured to communicate between the command processor and the shader core,
wherein a display shader is a program that is sent by the command processor to be executed on the shader core, the display shader configured to:
receive frame data, wherein the frame data includes at least a portion of a rendered frame;
receive parameters for modifying the frame data; and
applying the parameters to the frame data to create a modified frame.

15. The non-transitory computer-readable storage medium according to claim 14, wherein the shader core includes a priority mechanism wherein the display shader can be executed with a higher priority than other processes on the shader core.

16. The non-transitory computer-readable storage medium according to claim 14, the processor further comprising:
a buffer, configured to receive the modified frame from the display shader.

17. The non-transitory computer-readable storage medium according to claim 14, wherein the instructions are hardware description language (HDL) instructions used for the manufacture of a device.
